(19) United States
(12) Patent Application Publication
(10) Pub. No.: US 2008/0049648 A1
(43) Pub. Date: Feb. 28, 2008

(54) METHOD AND APPARATUS FOR POLICY MANAGEMENT FOR AN INTERNET PROTOCOL MULTIMEDIA SUBSYSTEM BASED WIRELESS COMMUNICATION SYSTEM

(75) Inventors: Liang Q. Liu, Freshbrook (GB); Jose Miguel M. Torres, Madrid (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/757,471

(22) Filed: Jun. 4, 2007

Related U.S. Application Data
(60) Provisional application No. 60/823,663, filed on Aug. 28, 2006.

(51) Int. Cl. H04B 7/00

(52) U.S. Cl. 370/310

(57) ABSTRACT

An Internet Protocol Multimedia Subsystem (IMS)-based communication system comprising multiple access networks, wherein each access network of the multiple access networks implements a different transport protocol than the other access networks of the multiple access networks, includes an application plane Quality of Service (QoS) policy server that, with the support of a Quality of Service (QoS) Agent, coordinates and manages QoS policies across the multiple transport networks, thereby providing for centrally consistently managed QoS policies, which policy management is transport control plane and network topology agnostic.

### REFERENCE(S) TO RELATED APPLICATIONS

The present application claims priority from provisional application Ser. No. 60/823,663, entitled “METHOD AND APPARATUS FOR POLICY MANAGEMENT IN AN INTERNET PROTOCOL MULTIMEDIA SUBSYSTEM-BASED COMMUNICATION SYSTEM,” filed Aug. 28, 2006, which is commonly owned and incorporated herein by reference in its entirety.

### FIELD OF THE INVENTION

The present invention relates generally to fixed and mobile converged communication (FMC) systems, and, in particular, to policy management in an Internet Protocol Multimedia Subsystem (IMS)-based FMC communication system.

### BACKGROUND OF THE INVENTION

Telecoms & Internet converged Services & Protocols for Advanced Networks (TISPAN) is a standards body that defines a Next Generation Networking (NGN) architecture for both fixed networks and migration from circuit switched networks to packet-based networks with an architecture that can serve in both. TISPAN NGNs are based upon the concept of cooperating subsystems sharing common components and defines means of providing communications services over multiple networks by defining a generic means of creating services that is independent of any specific underlying network technology, regardless of whether the underlying network is circuit switched or packet-based, fixed or mobile. This subsystem-oriented open architecture enables the addition of new subsystems over the time to cover new demands and service classes and ensures that the network resources, applications, and user equipment are common to all subsystems, thereby facilitating end user, terminal and service mobility.

One of the key subsystems of the TISPAN NGN architecture is based upon the 3GPP (Third Generation Partnership Project) IP Multimedia Subsystem (IMS), thereby enabling service providers to deploy Internet Protocol (IP)-based, multimedia communication services over both the fixed wireline and mobile telecommunications networks. With IMS, services can be provided over any IP network, such as GPRS (General Packet Radio Service), WLAN (Wireless Local Arean Network), DSL (Digital Subscriber Line), Cable, etc. The IMS infrastructure is IP-based, using standard Session Initiation Protocol (SIP)/IP signaling between the IMS core network elements. Originally designed for the mobile network, IMS can provide IP-based services to external circuit switched networks as well as external IP networks. The 3GPP Technical Specification (TS) 23.002 v6.6.0 defines IMS as comprising all the core-network elements providing IP multimedia services (such as audio, video, text, chat, etc., and combinations of them) over the packet switched domain of the core network. The overall network architecture behind this definition has two parts: an access network and a core network. The access network provides the wireless access points, customer premises access points, and links to the user, and the core network provides service control and session connectivity to other access points, to other fixed networks, and to application and service resources.

For example, FIG. 1 is a block diagram of an exemplary TISPAN NGN IMS-based communication system 100. From a functional perspective, IMS uses a layered architecture and comprises a set of interfaces, SIP proxies and servers (such as media servers), and media gateways (for connections to non-IP networks such as a PSTN (Public Switched Telephone Network)). There are three distinct operational planes within the IMS architecture: an application/services plane 102, a service control plane 120, and a transport control plane 150. Communication system 100 further includes a bearer plane 170 for an exchange of signaling and bearer traffic with an end user, for example, client device 190, over a physical medium.

Application/services plane 102 comprises one or more Application Servers 104 (one shown). The one or more ASs 104 are Session Initiation Protocol (SIP) entities that host and execute services and can operate in a number of modes, such as a SIP User Agent terminating function. AS 104 is coupled to a billing module 110 that provides a capability for billing system users for services provided to the users. AS 104 is further coupled to service control plane 120, and in particular to a Call Session Control Function (CSCF) 124 and a subscriber profile database 142, such as a Home Subscriber Server (HSS) or a User Profile Service Function (UPSF).

Service control plane 120 deals with session signaling and includes a number of distinct functions to process the signaling traffic flow, such as the Call Session Control Function (CSCF) 124 that may comprise a Proxy CSCF (P-CSCF) 126, a Serving CSCF (S-CSCF) 128, and/or an Interrogating CSCF (I-CSCF) 130, a Media Resource Function Controller (MRFC) 122, an Access Gateway Control Function (AGCF) 134, a Border Gateway Control Function (BGCF) 136, a Media Gateway Control Function (MGCF) 138, a Border Control Function (BCF) 140, and the subscriber profile database 142. CSCF 124, MRFC 122, AGCF 134, BGCF 136, and MGCF 138 may be collectively referred to as an IMS core network of communication system 100.

Transport control plane 150 provides for resource negotiation and scheduling for a transport of signaling and data over bearer plane 170 and for interworking between service control plane 120 and various data transport mechanisms available for a transport of signaling and data over bearer plane 170. Transport control plane 150 comprises one or more Resource and Admission Control Subsystems (RACSs) 154, 160 (two shown) and a Network Attachment Subsystem (NASS) 152. A Resource and Admission Control Subsystem (RACS) is the TISPAN subsystem responsible for policy control, resource reservations and admission control and provides, to applications, a mechanism for requesting and reserving resources from an access network, thereby enabling operators to enforce admission control on a per session basis. Each RACS 154, 160 includes a Policy Decision Function 156, 162, such as one or more of a Policy Decision Function (PDF) and a Service Policy Decision Function (SPDF), and may further include an Access Resource and Admission Control Function (A-RACF) or a Core Resource and Admission Control Function (C-RACF). Each PDF/SPDF 156, 162 is generally responsible for interfacing to the service subsystems in the application layer and allowing those systems to request reserved network resources from an NGN access network and core network. When the PDF/SPDF receives one of these requests, it applies policy rules that can be specified by each service provider so as to define how its network will work. The policies may define, for example, subscriber authorization for session service, subscriber entitlement check for content permissions, an amount of resources available for various types of service, the mechanism by which admission control be done, network admission control, and Quality of Service (QoS).

A PDF/SPDF may interface to the A-RACF to reserve access bandwidth resources. Each RACS 154, 160 can support multiple types of access networks by deploying multiple A-RACFs—one for each access network type. The RACS is the point where policy control is injected into the TISPAN architecture and is the mechanism whereby features such as oversubscription, guaranteed QoS, and similar network-level capabilities can be exposed to the various subsystems of the TISPAN architecture. NASS 152 is essentially a repository of data associated with end users. The NASS holds the policy information and the user location information and provides IP address allocation to the actual terminal equipment out in the network, user authentication, and authorization of network access and access network configuration based on a user's profile.

Bearer plane 170 provides the physical means for an exchange of data and signaling between an infrastructure 102, 120, 150, 170 of communication system 100 and an end user, such as client device 190, via any one of a variety of wireless and wireline access networks. For example, as depicted in FIG. 1, the infrastructure of communication system 100 is capable of communicating with client device 190 via a fixed broadband access network 174, a radio access network, for example, a GPRS access network comprising a GPRS support node (GSN) 176, a radio network controller (RNC) 178, and a base transceiver station (BTS) 180, and a conventional wireline network, for example, a network comprising a media gateway 182, such as one or more of a Media Gateway Function (MGF), Signaling Gateway Function (SGF), and Border Gateway Function (BGF), and a wireline network 184, such as a Public Switched Telephone Network (PSTN) or an Integrated Services Digital Network (ISDN). Bearer plane 170 further includes a Media Resource Function Processor (MRFP) 172 that provides a range of functions for multimedia resources, including a provision of resources to be controlled by MRFC 122, a mixing of incoming media streams, a sourcing of media streams (for multimedia announcements), and a processing of media streams.

Fixed-mobile convergence (FMC), that is, a convergence of wireline and wireless devices into a single telecommunications system, proposes to deliver different IP services over multiple access technologies, such as DSL, WLAN, GSM (Global System for Mobile Communications), GPRS, and W-CMDA (Wideband Code Division Multiple Access), to a hybrid device that supports the multiple access technologies. Under FMC, IP-based AS 104 interoperates with circuit switched and packet-based, such as IP-based, networks via media and signaling gateways. However, a drawback to currently proposed FMC implementation over the TISPAN NGN system is that existing mobile and fixed networks have certain levels of QoS differentiation and QoS control policies are mostly situated in the transport control plane, that is, in transport networks as currently specified in 3GPP PCC, ITU-T RACF, MMD PM and TISPAN RACS. As fixed and mobile operators merge their fixed and mobile networks and provide a common set of applications over such networks, subscribers in the fixed and the mobile domains will expect the same user experience regardless of whether they are served in the fixed or mobile transport networks. However, the policy decision functions (PDF/SPDF) currently operate independently in each of the respective types of transport networks and do not communicate directly to coordinate their policies rules for a particular user application in order to provide a consistent user experience.

Therefore, a need exists for a coordinated and consistent QoS policy control across multiple transport networks of different types in an IMS-based TISPAN NGN environment without introducing new open interfaces, as defining new interfaces and protocols between these policy decision functions in the different transport networks would be a long and cumbersome process.

### BRIEF DESCRIPTION OF THE DRAWINGS

FIG. 1 is a block diagram of an exemplary prior art TISPAN IMS-based communication system.

FIG. 2 is a block diagram of an exemplary TISPAN IMS-based communication system in accordance with an embodiment of the present invention.

FIG. 3 is a block diagram of signaling interfaces among various elements of the communication system of FIG. 2 in accordance with an embodiment of the present invention.

FIG. 4 is a block diagram of a client device of FIG. 2 in accordance with an embodiment of the present invention.

FIG. 5 is a block diagram of a Call Session Control Function of FIG. 2 in accordance with an embodiment of the present invention.

FIG. 6 is a block diagram of an Application Quality of Service Policy Server (AQoSPS) of FIG. 2 in accordance with an embodiment of the present invention.

FIG. 7 is a signal flow diagram illustrating a registration of a client device of FIG. 2 registers with an AQoSPS of FIG. 2 in accordance with an embodiment of the present invention.

FIG. 8 is a signal flow diagram illustrating an initiation of a QoS-based handoff by the communication system of FIG. 2 in accordance with another embodiment of the present invention.

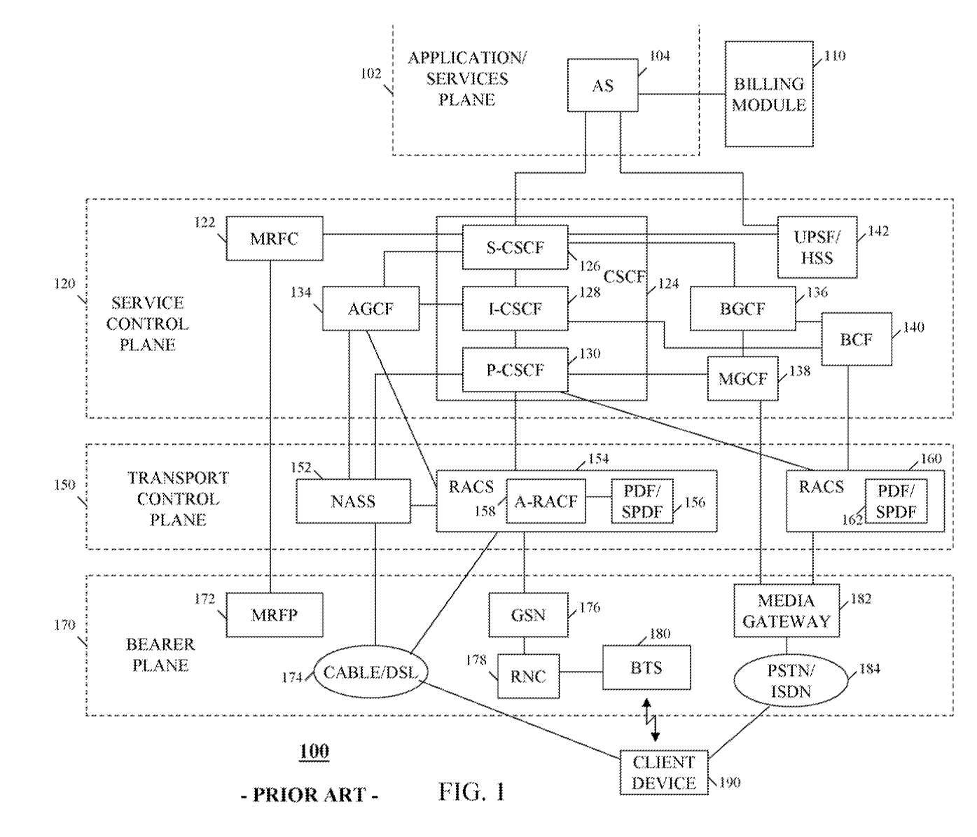

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and apparatus for a coordinated and consistent Quality of Service (QoS) policy control across multiple transport networks of different types in an IP Multimedia Subsystem (IMS)-based TISPAN NGN environment without introducing new open interfaces, an Internet Protocol Multimedia Subsystem (IMS)-based communication system is provided that includes an application plane Quality of Service (QoS) policy server that, with the support of a QoS Agent, coordinates and manages QoS policies across the multiple transport networks, thereby providing for consistently managed QoS policies, which policy management is transport control plane and network topology agnostic.

Generally, an embodiment of the present invention encompasses an apparatus for QoS policy management in an IMS-based communication system comprising multiple access networks, wherein each access network of the multiple access networks implements a different transport protocol than the other access networks of the multiple access networks. The apparatus comprises an application QoS policy server having at least one memory device that maintains QoS policies associated with each network of the plurality of networks and a processor that is configured to manage the QoS policies.

Another embodiment of the present invention encompasses a method for QoS policy management in an IMS-based communication system comprising multiple access networks, wherein each access network of the multiple access networks implements a different transport protocol than the other access networks of the multiple access networks. The method includes maintaining, by an application server, QoS policies associated with each network of the multiple access networks and managing the QoS policies at an application plane.

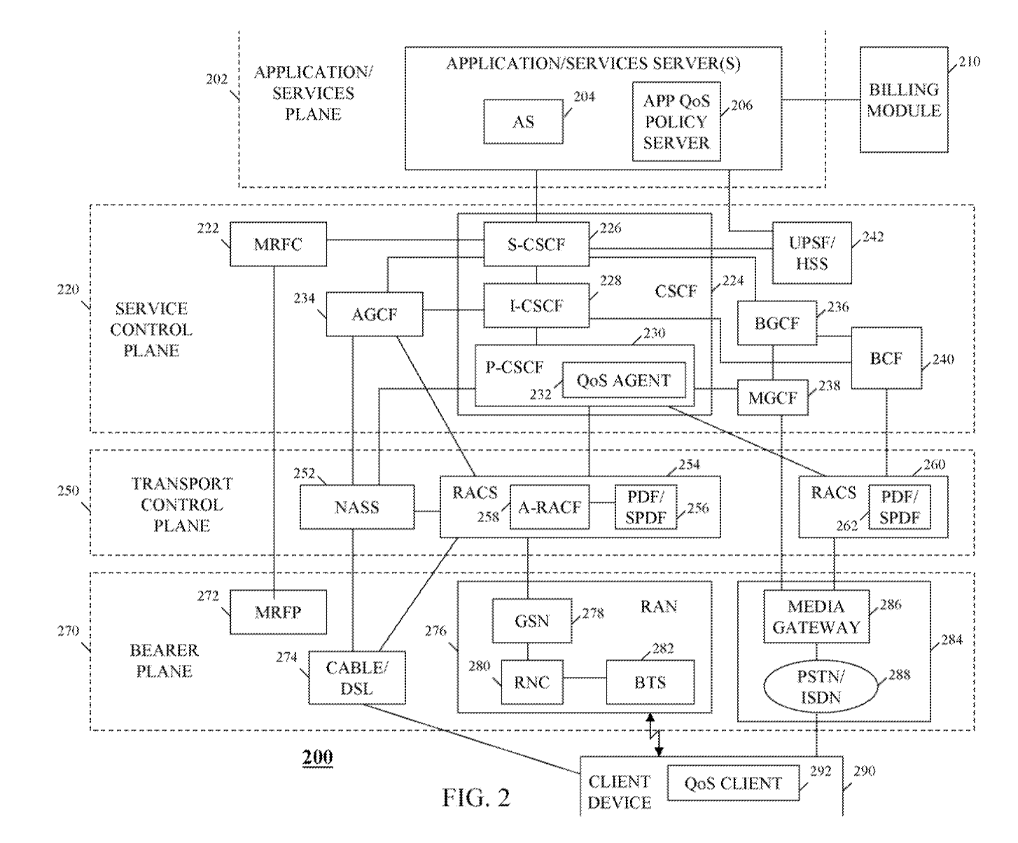

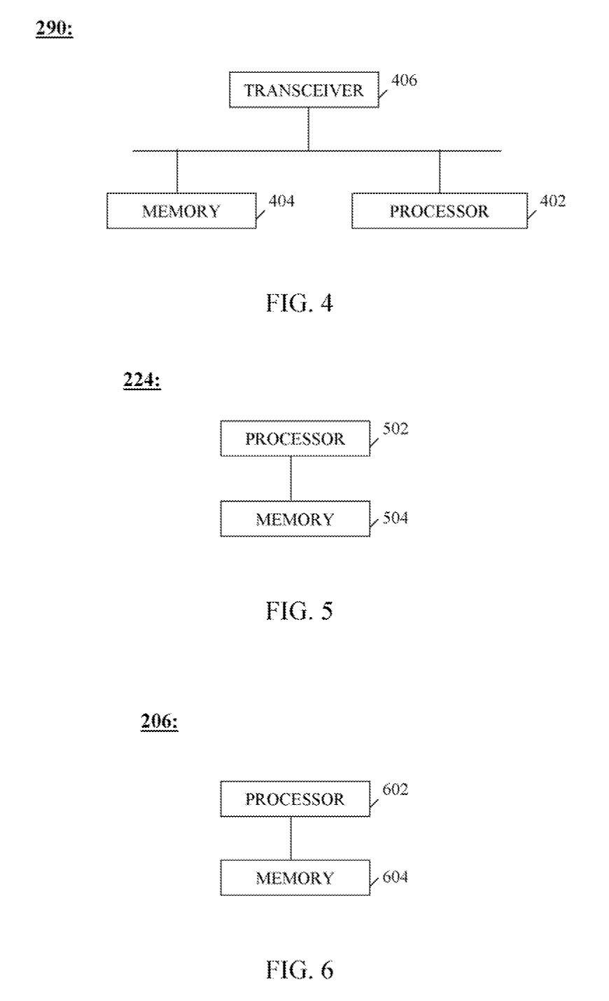

Turning now to the drawings, the present invention may be more fully described with reference to FIGS. 2-8. FIG. 2 depicts a block diagram of an architecture of an IMS-based communication system 200 in accordance with an embodiment of the present invention. In order to facilitate an exchange of data among multiple components of a cellular communication system, understandings known as protocols have been developed. The protocols specify the manner of interpreting each data bit of a data packet exchanged across a network. In order to simplify network designs, well-known techniques of layering the protocols have been developed. Protocol layering divides the network design into functional layers and then assigns separate protocols to perform each layer's task. Layered representation of protocols is commonly known as a protocol stack. Individual layers within protocol stacks are logically, if not physically, terminated within corresponding layers of other protocol stacks. As depicted in FIG. 2, there are three distinct operational layers, or planes, within the IMS architecture, that is, an application/services plane 202, a service control plane 220, and a transport control plane 250. Communication system 200 further includes a bearer plane 270 for an exchange of signaling and bearer traffic with a client device 290 over a physical medium.

Application plane 202 comprises one or more Application Servers (ASs) 204 (one shown) and an Application Quality of Service Policy Server (AQoSPS) 206. AS 204 is a Session Initiation Protocol (SIP) entity that hosts and executes services and can operate in a number of modes, such as a SIP User Agent terminating function. Each of AS 204 and AQoSPS 206 is coupled to a billing module 210 that provides a capability for billing system users for services provided to the users. Each of AS 204 and AQoSPS 206 is further coupled to service control plane 220, and in particular to a Call Session Control Function (CSCF) 224 and a subscriber profile database 242, such as a Home Subscriber Server (HSS) or a User Profile Service Function (UPSF).

AQoSPS 206 also is a SIP entity that provides Quality of Service (QoS) policy management. For example, AQoSPS 206 determines QoS policies, for example, E2E (end-to-end) QoS Metrics (for example, delay or jitter) and application QoS (for example, frame rate, codec) for a communication session and evaluates such policies to make sure that, from a resource perspective, a particular application's needs can be met and can be delivered through the network. AQoSPS 206 further evaluates alternative QoS, for example, when a subscribed QoS cannot be met or a particular session or program requires a higher QoS. AQoSPS 206 further initializes default QoS policy information, for example, initial Filter Criteria (iFC) for a communication session. AQoSPS 206 maintains QoS Policy information associated with all possible access networks 274, 276, and 284 (three shown) included in communication system 200. For example, when a Trigger Point (QoS reporting) indicates a poor QoS estimation, AQoSPS 206 may interrogate a RACS, such as RACS 254 and 260, associated with an alternative access network, such as one of multiple access networks 274, 276, and 284, via a QoS Agent, such as QoS Agent 232, to check whether better communication conditions can be offered to a served client device, such as client device 290. The QoS Policy service triggering information (for example, an iFC) is part of a profile of a user associated with the client device, which profile may be downloaded to an S-CSCF, such as S-CSCF 226, from a subscriber profile database, such as subscriber profile database 142, during registration of the client device (via well-known 3^{rd} party registration procedures) and retrieved by AQoSPS 206 from the S-CSCF or which profile may be downloaded directly by the AQoSPS during the registration.

By providing for QoS policy management at application plane 202, communication system 200 provides for centrally managed QoS policies, which policy management is transport control plane and network topology agnostic. By providing an architecture where all applications request QoS policies from a centralized, network independent, application-level policy layer, communication system 100 provides better application scalability and better facilitates nomadic and roaming scenarios than the prior art—an application does not need to know how or where the user is connected to the network. In addition, as a converged multiservice environment may involve millions of subscribers, each with many services and devices, a centralized QoS policy management scenario will allow service providers to more easily exercise control over QoS policies.

As noted above, communication system 200 further comprises a service control plane 220, a transport control plane 250, and a bearer plane 270. Service control plane 220 deals with session signaling and includes a number of distinct functions to process the signaling traffic flow. Service control plane 220 includes a Call Session Control Function (CSCF) 224 that implements one or more of a Proxy CSCF (P-CSCF) 226, a Serving CSCF (S-CSCF) 228, and an Interrogating CSCF (I-CSCF) 230. Service control plane 220 further includes a Border Gateway Control Function (BGCF) 236 coupled to the CSCF, a Media Gateway Control Function (MGCF) 238 coupled to the CSCF and the BGCF, a Media Resource Control Function (MRFC) 222 coupled to the CSCF, an Access Gateway Control Function (AGCF) 234 coupled to the CSCF, a Border Control Function (BCF) 240 coupled to the CSCF and the BGCF, and a subscriber profile database 142, such as a Home Subscriber Server (HSS) or a User Profile Service Function (UPSF). Together, MRFC 222, CSCF 224, AGCF 234, BGCF 236, MGCF 238, and BCF 240 are collectively referred to herein as an IMS core network of communication system 100.

As is known in the art, MGCF 138 communicates with CSCF 224 and controls the connections for media channels in an associated gateway, such as gateway 182. MGCF 138 performs protocol conversion between ISUP and the IMS call-control protocols. Gateway 182 may terminate bearer channels from a switched circuit network and media streams from a packet network. The gateway may support media conversion, bearer control, and payload processing. MRFC 222 controls the media stream resources in a Media Resource Function Processor (MRFP) 272. MRFC 222 interprets information coming from an AS and S-CSCF and controls the MRFP accordingly. It also generates CDRs. BGCF 236 controls the transfer of calls to and from a PSTN 288. BCF 240 provides overall control of the boundary between different service provider networks. Subscriber profile database 242 maintains a service profile, such as services subscribed to by, and capabilities of, each client device subscribing to communication system 200.

CSCF 224 serves as a centralized routing engine, policy manager, and policy enforcement point to facilitate the delivery of multiple real-time applications using IP transport. It is application-aware and uses dynamic session information to manage network resources (feature servers, media gateways, and edge devices) and to provide advance allocation of these resources depending on the application and user context. I-CSCF 228 is the contact point within an operator's network for all connections destined for a user of that network, or for a roaming user currently located within that network's service area. There may be multiple I-CSCFs within an operator's network. S-CSCF 226 is responsible for identifying the user's service privileges, selecting access to an application server such as AS 204 and AQoSPS 206, and providing access to those servers.

P-CSCF 230 is the SIP signaling contact point in the IMS core network for a client device such as client device 290. P-CSCF 230 is responsible for forwarding SIP registration messages from a subscriber's endpoint, that is, from a User Element of a client device, such as client device 290, in a visited network to I-CSCF 228 and for subsequent call set-up requests and responses to S-CSCF 226. P-CSCF 230 maintains a mapping between a logical subscriber SIP Uniform Resource Identifier (URI) address and a physical User Element IP address and a security association for both authentication and confidentiality. P-CSCF 230 further supports admission control by interfacing with a Resource and Admission Control Subsystem (RACS) 254, 260 and a Policy Decision Function/Service Policy Decision Function (PDF/SPDF) 256, 262 with respect to session-level policies, such as subscriber authorization for session service and a subscriber entitlement check for content permissions, and network admission control. However, QoS policies are managed by AQoSPS 206. Accordingly, CSCF 224, and preferably P-CSCF 230, further includes a QoS Agent 232 that interfaces with AQoSPS 206 and that acts as an agent between the AQoSPS and the functionality of transport control plane 250 and further between AQoSPS 206 and an application layer QoS client implemented in a client device, such as a QoS client 292 implemented on client device 290. More particularly, QoS Agent 232 acts as an anchor for QoS policy management regardless of a transport/access network, such as access networks 274, 276, and 284, serving the client device. QoS Agent 232 provides whatever interworking is required so that the application layer QoS client operating on the client device is able to communication with AQoSPS 206, for example, proving protocol conversion and relay for communications between AQoSPS 206 and the client device via each of a variety of transport/access networks. QoS Agent 232 further interfaces to a Resource and Admission Control Subsystem (RACS), and in particular to an Access Resource and Admission Control Function (A-RACF), to reserve access bandwidth resources.

Transport control plane 250 provides for resource negotiation and scheduling for a transport of signaling and data over bearer plane 270 and for interworking between service control plane 220 and various data transport mechanisms available for a transport of signaling and data via the bearer plane. Transport control plane 250 comprises one or more (RACS) 254, 260 and a Network Attachment Subsystem (NASS) 252. Each RACS 254, 260 includes a respective Policy Decision Function 256, 262, such as one or more of a Policy Decision Function (PDF) and a Service Policy Decision Function (SPDF), and may further include an Access Resource and Admission Control Function (A-RACF) 258. Each PDF/SPDF 256, 262 is generally responsible for interfacing to the service subsystems in the application layer, applying session-level policies to a session such as subscriber authorization for session service and a subscriber entitlement check for content permissions, and for network admission control. NASS 152 is essentially a repository of data associated with end users. The NASS holds policy information and the user location information and provides IP address allocation to the actual terminal equipment out in the network, user authentication, and authorization of network access and access network configuration based on a user's profile.

Bearer plane 270 provides the physical means for an exchange of data and signaling between an infrastructure 202, 220, 250, 270 of communication system 200 and an end user, such as client device 290, via any one of multiple wireless and wireline access networks 274, 276, 284, wherein each access network of the multiple access network 274, 276, 284 implements a different transport protocol than the other access networks of the multiple access network. For example, as depicted in FIG. 2, the infrastructure of communication system 200 is capable of communicating with client device 190 via a fixed broadband access network 274, a radio access network (RAN) 276, and a conventional wireline network 284. RAN 276 may comprise a Third Generation Partnership Project (3GPP) access network comprising a GPRS support node (GSN) 278, a radio network controller (RNC) 280, and a base transceiver station (BTS) 282, and conventional wireline network 284 may comprise a public or enterprise wireline network 288, such as a Public Switched Telephone Network (PSTN) or an Integrated Services Digital Network (ISDN), and a media gateway 286, such as one or more of a Media Gateway Function (MGF), Signaling Gateway Function (SGF), and Border Gateway Function (BGF), that interfaces between the IMS core network and wireline network 288. Bearer plane 270 further includes a Multimedia Resource Function Processor (MRFP) 272 that provides a range of functions for multimedia resources, including a provision of resources to be controlled by MRFC 222, a mixing of incoming media streams, a sourcing of media streams (for multimedia announcements), and a processing of media streams.

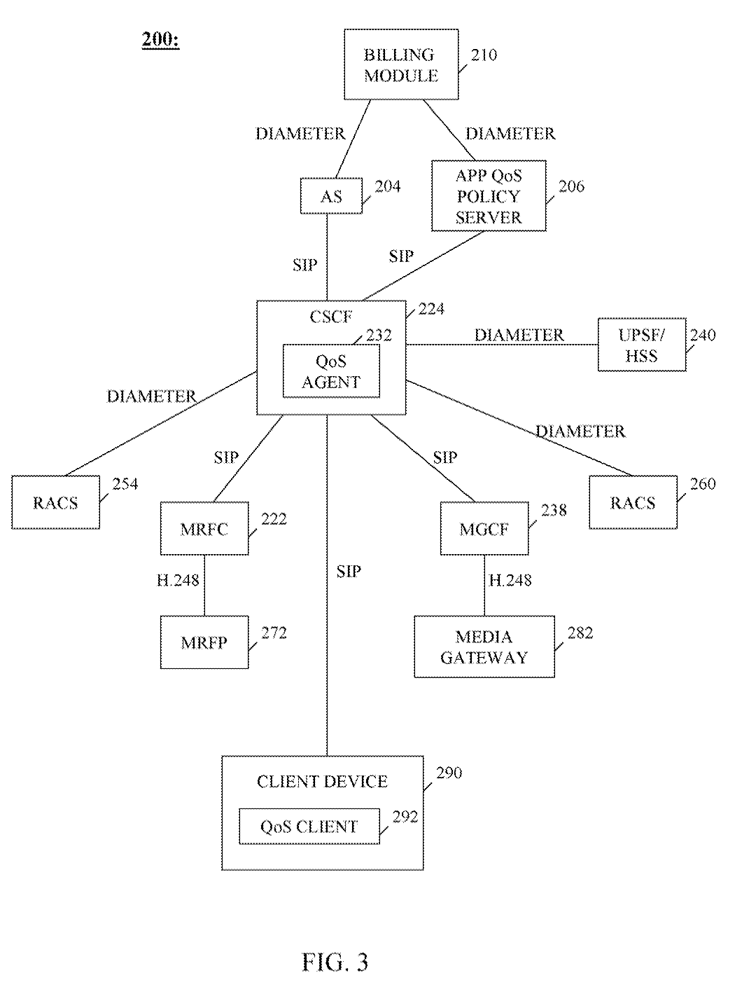

FIG. 3 is a block diagram of signaling interfaces among various elements of the communication system of FIG. 2 in accordance with an embodiment of the present invention. AS 204 and AQoSPS 206 are each coupled by a SIP interface to CSCF 224, and thereby to P-CSCF 230 and QoS Agent 232. Each of AS 204 and AQoSPS 206 are coupled further by a Diameter interface to Billing Module 210. CSCF 224, and more particularly P-CSCF 230 and QoS Agent 232, is coupled further to each of MRFC 222, MGCF 238, and client device 290, and thereby to QoS Client 292, by a SIP interface. MRFC 222 and MGCF 238 further are respectively coupled to MRFP 272 and media gateway 286 by an H.248 interface. CSCF 224, and more particularly P-CSCF 230, is coupled further to each of RACS 240 and 254 by a Diameter interface. SIP, H.248, and Diameter protocols all are well-known in the art and will not be described here in greater detail.

Referring now to FIGS. 4, 5, and 6, a block diagram is provided of each of client device 290, CSCF 224, and AQoSPS 206, respectively, in accordance with an embodiment of the present invention. Client device 290 comprises a user's equipment (UE) such as but not limited to a cellular telephone, a radio telephone, a personal digital assistant (PDA) with radio frequency (RF) capabilities, or a wireless modem that provides RF access to digital terminal equipment (DTE) such as a laptop computer. Each of client device 290, CSCF 224, and AQoSPS 206 includes a respective processor 402, 502, 602, such as one or more microprocessors, microcontrollers, digital signal processors (DSPs), combinations thereof or such other devices known to those having ordinary skill in the art. Each of client device 290, CSCF 224, and AQoSPS 206 further includes a respective at least one memory device 404, 504, 604 associated with the corresponding processor, such as random access memory (RAM), dynamic random access memory (DRAM), and/or read only memory (ROM) or equivalents thereof, that store data and programs, such as Session Initiation Protocol (SIP)-related programs, that may be executed by the processor and that allow the client device, CSCF, and AQoSPS to perform all functions necessary to operate in communication system 200.

The processors 402, 502 of each of client device 290 and CSCF 224 further respectively implement an application layer, or plane, QoS client 292 and a service control layer, or plane, QoS Agent 232 based on instructions stored in the respective at least one memory device 404, 504 of the client device and CSCF. Client device 290 further includes an at least one transceiver 406 that facilitates a communication by the client device with the IMS core network via each of the multiple access networks 274, 276, and 284 of communication system 200.

AQoSPS 206 further maintains, in the at least one memory device 604 of the AQoSPS, routing information associated with each RACS 254, 260 serving the multiple access networks 274, 276, 282 and with a PDF/SPDF 256, 260 associated with each RACS, and a database of QoS policy information and initial Filter Criteria (iFCs) for all of the multiple access networks 274, 276, 282. Thus AQoSPS 206 is aware of QoS policies and iFCs that are common to each of the multiple access networks and QoS policies and iFCs that do not overlap the multiple access networks. By being aware of the QoS policies and iFCs implemented by each of the multiple access networks 274, 276, 282, AQoSPS 206 is able to determine whether a handoff of a client device, such as client device 290, from one access network of the multiple access networks to another access network of the multiple access networks is appropriate. Furthermore, by maintaining QoS policy information and initial Filter Criteria (iFCs) for all of the multiple access networks 274, 276, 282, AQoSPS 206 is able to centrally administer Quality of Service (QoS) for all of the multiple access networks 274, 276, 282. Furthermore, when an end user, such as client device 290, registers with the IMS core network, AQoSPS 206 may download from subscriber profile database 242 or CSCF 224, and store in the at least one memory device 604 of the AQoSPS, at least a portion of the associated user profile, such as services and QoS subscribed to by the user.

The embodiments of the present invention preferably are implemented within each of client device 290, CSCF 224, and AQoSPS 206, and more particularly with or in software programs and instructions stored in the at least one memory devices and executed by the processors of the client device, CSCF, and AQoSPS. However, one of ordinary skill in the art realizes that the embodiments of the present invention alternatively may be implemented in hardware, for example, integrated circuits (ICs), application specific integrated circuits (ASICs), and the like, such as ASICs implemented in the user device or IMS Server, and all references to ‘means for’ herein may refer to any such implementation of the present invention. Based on the present disclosure, one skilled in the art will be readily capable of producing and implementing such software and/or hardware without undo experimentation.

Communication system 200 comprises a wireless packet data communication system. In order for MSs 202 and 208 to establish a packet data connection with access network 220, each of the MSs and access network operates in accordance with well-known wireless telecommunications protocols. By operating in accordance with well-known protocols, a user of an MS can be assured that the MS will be able to communicate with access network 220 and establish a packet data communication link with an external network via the access network. Preferably, communication system 200 operates in accordance with the TISPAN NGN standards, which standards specify wireless telecommunications system operating protocols, including radio system parameters and call processing procedures. However, those who are of ordinary skill in the art realize that communication system 200 may operate in accordance with any one of a variety of wireless communication systems delivering Internet Protocol (IP)-based multimedia communication services over multiple telecommunications networks.

When an IP session is set up, policies are determined by a PDF/SPDF, such as PDF/SPDFs 256 and 262, and AQoSPS 206 and that govern a treatment of the session with respect to resources. Typically, the policies are captured as a set of rules, most typically defined as a set of conditions that have to be met and a resulting set of actions that are to be taken. The rules may be based on either static information, such as would be contained in a user's profile, or are based on some dynamic state information, such as a current amount of bandwidth being used on a particular network link. AQoSPS 206 provides a centralized QoS policy management function that makes sure that a QoS can be employed by, and grants a QoS to, a service, that is, determines whether a particular application's QoS needs can be met and can be provided by a network.

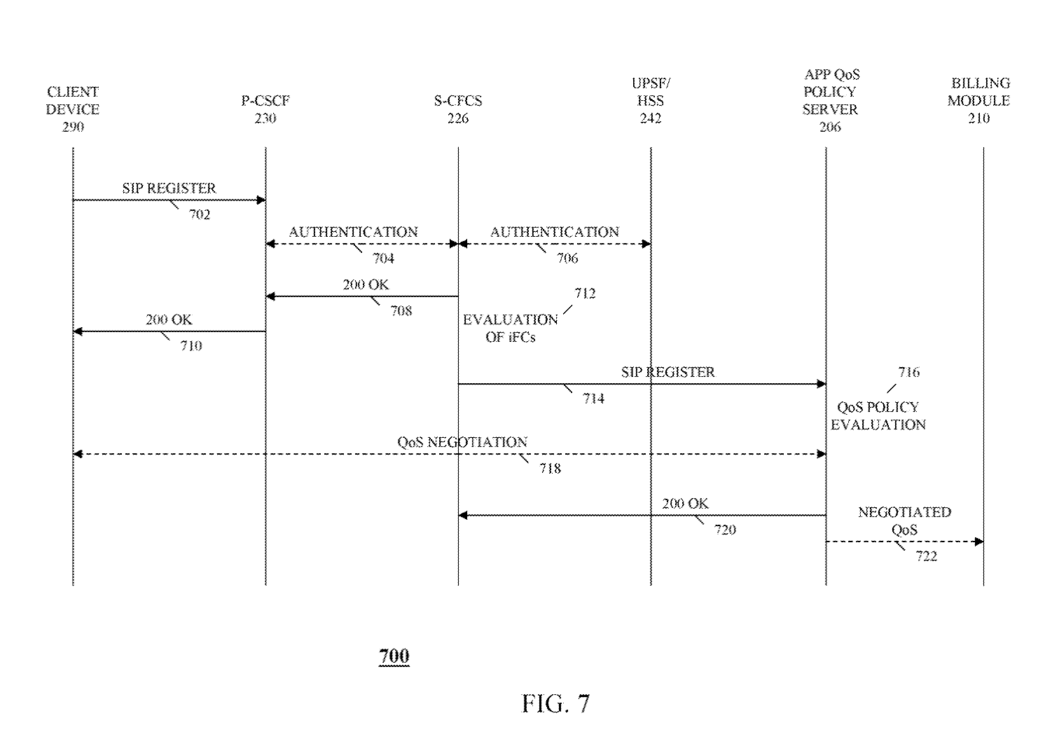

Referring now to FIG. 7, a signal flow diagram 700 is provided that depicts a client device 290 registration with AQoSPS 206 in accordance with an embodiment of the present invention. Signal flow diagram 700 begins when client device 290 initiates (702) an IMS registration by assembling and conveying a SIP Register message to CSCF 224, and more particularly to P-CSCF 230. As is known in the art, the SIP Register message includes an identifier, such as a SIP URI, associated with the registration device and a call identifier. In addition, the SIP Register message may indicate an application or service invoked by the client device.

In response to receiving the registration message, CSCF 224, and more particularly P-CSCF 230 via S-CSCF 226, may authenticate (704, 706) client device 290 by reference to subscriber profile database 242. As part of the authentication process, S-CSCF 226 downloads and stores a profile associated with client device 290 from subscriber profile database 242, which profile includes services subscribed to by a user associated with the client device and may further include QoS Policy service triggering information, for example, iFCs, that are part of the user profile. As is known in the art, an iFC specifies conditions that require a given AS. However, if S-CSCF 226 already has stored a valid set of iFCs associated with client device 290, for example, from a previous request, then the S-CSCF may not need to authenticate the client device via the subscriber profile database.

In response to receiving the registration message from client device 290, and further in response to authenticating the client device if authentication is required, CSCF 224, and more particularly S-CSCF 226, acknowledges (708, 710) the SIP Register message by conveying a confirmation message, preferably a SIP 200 OK message, to the client device via P-CSCF 230. In addition, in response to receiving the registration message from the client device 290 (and to authenticating the client device if authentication is required), CSCF 224, and more particularly S-CSCF 226, evaluates (712) the downloaded iFCs to determine if any trigger applies to the client device. Based on the evaluation of the downloaded iFCs, CSCF 224, and more particularly S-CSCF 226, routes (714) a SIP-based registration of client device 290 to AQoSPS 206, preferably by forwarding the SIP Register message to the AQoSPS. For example, the iFCs may indicate that particular SIP messages, such as a SIP Register message or a SIP Register message that is modified to include a QoS proposal, are to be forwarded to AQoSPS 206. CSCF 224 may further inform AQoSPS 206 of an access network serving the client device, for example, by identifying a RACS and/or PDF/SPDF serving the client device.

In response to receiving the SIP-based registration from CSCF 244, AQoSPS 206 evaluates (716) the QoS policies associated with the indicated application or service, and may further evaluate the QoS policies associated with the serving access network and/or subscribed to the client device, that is, client device 290, and determines whether to grant a QoS to the client device. When the application or service may be provided to client device 290 via multiple access networks, AQoSPS 206 may further determine whether the QoS requirements of the indicated application or service may be met by one or more of the multiple access networks. When the QoS requirements of the indicated application or service may be met by an access network, and in various other embodiments further is determined by the AQoSPS to be subscribed to and/or supported by the client device, AQoSPS 206 grants (720) the QoS to the client device by conveying a SIP message, preferably a SIP 200 OK message, to CSCF 224, and more particularly S-CSCF 226, granting a QoS. Signal flow 700 then ends.

In another embodiment of the present invention, AQoSPS 206 may further negotiate (718) a Service Level Agreement (SLA) associated with a QoS with client device 290, and more particularly QoS client 292 of the client device. In such an embodiment, AQoSPS 206 establishes a peer-to-peer communication with an application layer, and more particularly QoS client 292, of client device 290. In one such an embodiment, the QoS client may modify a SIP registration message to include a proposed QoS associated with the indicated application or service. In another such embodiment, the QoS client may encapsulate a requested QoS in another SIP message conveyed by the client device to the AQoSPS. In response to receiving the proposed QoS and to determining the QoS policies associated with the indicated application or service, AQoSPS 206 determines (716) whether to grant the requested QoS.

In determining whether to grant the requested QoS, AQoSPS 206 may query CSCF 224 or subscriber profile database 242 for a QoS subscribed to by a user associated with client device 290. When client device 290, and more particularly QoS client 292 of the client device, proposes a QoS that is acceptable to AQoSPS 206, the AQoSPS may respond to the proposal by conveying a SIP message acknowledging the proposal. On the other hand, when AQoSPS 206 does not accept the proposed QoS, then the AQoSPS may respond with a SIP message rejecting the proposal and/or respond with a SIP message countering with a different proposed QoS. QoS client 292 of client device 290 may then accept the counter-proposal or negotiations may then continue back-and-forth until a final rejection or acceptance of a QoS occurs. In response to granting a QoS for the requested service, AQoSPS 206 may inform (722) Billing Module 210 of the granted QoS so that the Billing Module may charge the client device appropriately for the provision of the service, for example, charging a higher rate for he service when a higher QoS is granted. Signal flow diagram 700 then ends.

In yet another embodiment of the present invention, as part of determining a QoS for provision of the application or service, AQoSPS 206 further may select an access network 274, 276, 284 for provision of the application or service to client device 290. That is, AQoSPS 206 is aware of the QoS capabilities of each access network of the multiple access networks 274, 276, 284 and may select an access network for provision of the service. In order to determine an appropriate access network, AQoSPS 206 may query, via QoS Agent 232, a RACS 254, 260 associated with each access network as to available bandwidth, congestion conditions, and/or reported channel conditions. AQoSPS 206 may then convey a granted QoS to the RACS 254, 260, and more particularly the PDF/SPDF 256, 262, associated with the selected access network 274, 276, 284.

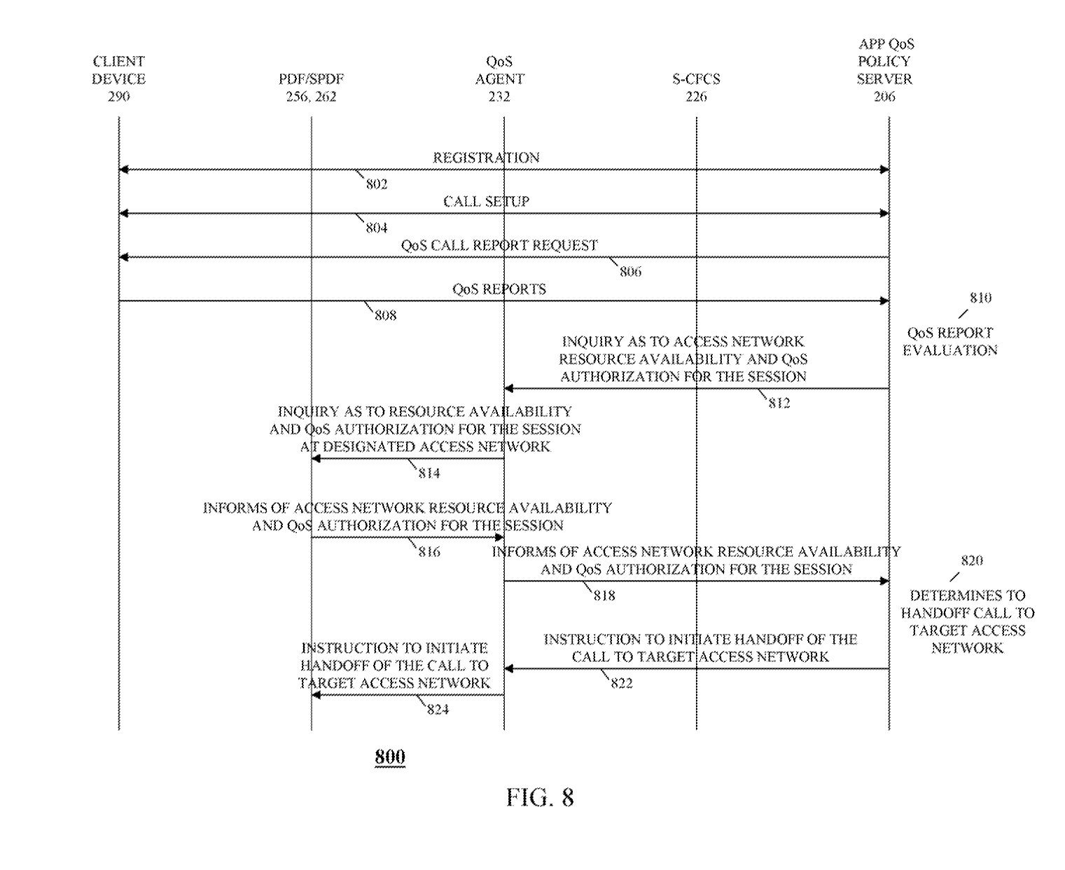

Referring now to FIG. 8, a signal flow diagram 800 is provided that illustrates an initiation of a QoS-based handoff by communication system 200 in accordance with still another embodiment of the present invention. Signal flow diagram 800 begins when client device 290 registers (802) with AQoSPS 206 and a communication session is set up (804) that includes one or more real-time bearers. As part of the session setup, AQoSPS 206 remains connected to the session for a receipt of signaling only, that is, AQoSPS 206 is not in the bearer path of the call.

At some point during the session, AQoSPS 206 requests (806), from client device 290, QoS call reports associated with a serving, or first, access network. For example, QoS call reports may be routinely provided, on an intermittent or periodic basis, to AQoSPS 206 by communication system 200 or AQoSPS 206 may convey a SIP Info message to the client device, which SIP Info message is modified to include a request for call reports. In one such embodiment of the present invention, AQoSPS 206 may request the QoS call reports in response to being informed by a RACS 254, 260 associated with the serving access network, and more particularly a respective PDF/SPDF 256, 262 of the serving RACS, that a provided QoS has deteriorated and/or is no longer acceptable for the application or service being provided. For example, a frequency and/or a maximum number of QoS call reports may be part of a bearer plane, and more particularly a physical layer, QoS profile associated with a provided service, which QoS profile is maintained in the at least one memory device 604 of AQoSPS 206. The QoS profile may further include a warning threshold indicating that a reported QoS is becoming unacceptably low. In response to establishing the communication session, or in response to receiving a request for QoS call reports, client device 290 conveys (808) QoS call reports to AQoSPS 206. AQoSPS 206 may further receive QoS call reports concerning access networks other than the first, serving access network from other client devices being served by those other access networks.

AQoSPS 206 evaluates (810) the QoS call reports received from client device 290. When AQoSPS 206 determines that the reported QoS is becoming unacceptably low, AQoSPS 206 may initiate a handoff of the communication session to a second, target access network of the multiple access network 274, 276, 284. That is, in response to determining that the reported QoS is becoming unacceptably low, AQoSPS 206 requests (812) CSCF 224, and in particular QoS Agent 232 of P-CSCF 230, to provide needed handoff information, such as resource, for example, bandwidth, availability in each of the other access networks of the multiple access network 274, 276, 284, any available channel condition information, and QoS authorization for the session, that is, a negotiated QoS, that is, a QoS is negotiated and subsequently granted by the network. In response to receiving the query from AQoSPS 206, QoS Agent 232 then queries (814) RACS, and in particular PDF/SPDFs, or transport plane Policy Enforcement Functions (PEPs) (not shown) associated with the other access networks for the requested handoff information.

In response to receiving the query from QoS Agent 232, each queried PDF/SPDF or PEP provides (816) the requested handoff information to QoS Agent 232 and the QoS Agent forwards (818) the information to AQoSPS 206. Based on the handoff information received from QoS agent 232, and further based on any operator policy maintained in the at least one memory device 604 of AQoSPS 206 and any user preferences maintained in the user's profile maintained by subscriber profile database 242, which user preferences are retrieved by the AQoSPS from the subscriber profile database or are requested by the AQoSPS from CSCF 224, AQoSPS 206 determines (820) whether to handoff the communication session and further determines a target access network of the other access networks. In response to determining to handoff the communication session to the target access network, AQoSPS 206 conveys (822, 824), via QoS agent 232, a SIP message to the PDF/SPDF or PEP serving the target access network instructing the PDF/SPDF or PEP to initiate a handoff the communication session to the target access network. Signal flow diagram 800 then ends.

By providing a coordinated QoS policy function at the application plane, or layer, and QoS policy control via a QoS Agent at the service control plane, or layer, NGN objectives for easy introduction of new services are achieved by disassociating QoS policy control from transport layer hardware and software. By providing a globalized QoS policy server, QoS policies can be easily coordinated across multiple access networks of different types and utilizing different transport layer protocols in an IMS-based TISPAN NGN environment. Furthermore, by providing an application plane QoS policy server that interacts with transport control plane, or layer, hardware and software via a service control plane QoS Agent, communication system 200 monitors and controls QoS in a harmonized manner without the need for additional interfaces or protocols.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. An apparatus for Quality of Service (QoS) policy management in an Internet Protocol Multimedia Subsystem (IMS)-based communication system comprising a plurality of access networks, wherein each access network of the plurality of access networks implements a different transport protocol than the other access networks of the plurality of access networks and wherein the apparatus comprises an application QoS policy server having:
at least one memory device that maintains QoS policies associated with each network of the plurality of networks; and
a processor that is configured to manage the QoS policies.

2. The apparatus of claim 1, wherein the processor further is configured to establish a peer-to-peer communication with an application layer of a client device and negotiate a Quality of Service associated with Service Level Agreement with a client device.

3. The apparatus of claim 2, further comprising the client device and wherein the client device comprises an application layer Quality of Service client that negotiates a QoS with the application QoS policy server.

4. The apparatus of claim 1, wherein the processor is configured to manage the Quality of Service policies (QoS) by evaluating QoS policies associated one or more access networks of the plurality of access networks and, based on the evaluation, granting a QoS for a communication session.

5. The apparatus of claim 4, wherein the processor is configured to manage the Quality of Service policies (QoS) by evaluating a QoS requirement of one or more of an application and a service and, based on the evaluations, granting a QoS for a communication session.

6. The apparatus of claim 4, wherein the processor is configured to manage the Quality of Service policies (QoS) by considering a subscribed QoS.

7. The apparatus of claim 1, wherein the processor is further configured to select an access network of the plurality of access networks for access by a client device.

8. The apparatus of claim 1, wherein the processor further is configured to initiate a handoff from a first access network of the plurality of access networks to a second access network of the plurality of access networks based on a Quality of Service provided by the first access network.

9. The apparatus of claim 8, wherein the processor is configured to initiate a handoff by requesting Quality of Service (QoS) reports from a client device served by the first access network, receiving the requested QoS reports, and initiating a handoff to the second access network based on the received QoS reports.

10. The apparatus of claim 9, wherein the processor is configured to initiate a handoff by querying a Policy Decision Function associated with the second access network for handoff information.

11. The apparatus of claim 10, wherein the processor queries the Policy Decision Function associated with the second access network via a service control plane Quality of Service Agent.

12. The apparatus of claim 11, further comprising the Quality of Service Agent, wherein the Quality of Service Agent relays QoS reports and acts as policy setting anchor and performs protocol conversion.

13. The apparatus of claim 12, wherein the Quality of Service Agent is implemented in a Call Session Control Function.

14. A method for Quality of Service (QoS) policy management in an Internet Protocol Multimedia Subsystem (IMS)-based communication system comprising a plurality of access networks, wherein each access network of the plurality of access networks implements a different transport protocol than the other access networks of the plurality of access networks and wherein the method comprises:
maintaining, by an application server, QoS policies associated with each multiple network of the plurality of multiple networks; and
managing the QoS policies at an application plane.

15. The method of claim 14, further comprising:
establishing a peer-to-peer communication with an application layer of a client device; and
negotiating Quality of Service associated with Service Level Agreement with the client device.

16. The method of claim 14, wherein managing comprises:
evaluating Quality of Service (QoS) policies associated one or more access networks of the plurality of access networks; and
granting a QoS for a communication session based on the evaluation.

17. The method of claim 16, wherein managing further comprises:
evaluating a Quality of Service (QoS) requirement of one or more of an application and a service; and
granting a QoS for a communication session based on the evaluations.

18. The method of claim 16, wherein the processor is configured to manage the Quality of Service policies (QoS) by considering a subscribed QoS.

19. The method of claim 14, further comprising selecting, at an application layer, an access network of the plurality of access networks for access by a client device.

20. The method of claim 14, further comprising initiating, at an application layer, a handoff from a first access network of the plurality of access networks to a second access network of the plurality of access networks based on a Quality of Service provided by the first access network.

21. The method of claim 20, wherein initiating a handoff comprises:
requesting Quality of Service (QoS) reports from a client device served by the first access network;
receiving the requested QoS reports; and
initiating a handoff to the second access network based on the received QoS reports.

22. The method of claim 21, wherein initiating a handoff further comprises querying a Policy Decision Function associated with the second access network for handoff information.

23. The method of claim 22, wherein querying a Policy Decision Function associated with the second access network comprises querying the Policy Decision Function via a service control plane Quality of Service Agent.

24. The method of claim 23, further comprising performing protocol conversion by the Quality of Service Agent.

25. The method of claim 23, further comprising implementing the Quality of Service Agent in a Call Session Control Function.
